(19) United States
(12) Patent Application Publication
(10) Pub. No.: US 2022/0063340 A1
(43) Pub. Date: Mar. 3, 2022

(54) TIRE WITH COMPOSITE TREAD AND METHOD OF MAKING

(71) Applicant: The Goodyear Tire & Rubber Company, Akron, OH (US)

(72) Inventors: Josh Aaron Phillipson, Brecksville, OH (US); Christopher David Dyrlund, Canton, OH (US); Duane Thomas Delaney, Canton, OH (US); Elizabeth Amelia RogenskiMitchell, Atwater, OH (US); Michael Stefan Skurich, North Canton, OH (US); Christian Jean-Marie Kaes, Schrondweiler (LU)

(21) Appl. No.: 17/355,332

(22) Filed: Jun. 23, 2021

Related U.S. Application Data
(60) Provisional application No. 63/073,139, filed on Sep. 1, 2020.

(51) Int. Cl. B60C 11/00; B60C 1/00

(52) U.S. Cl. CPC B60C 11/0008; B60C 2011/0016; B60C 1/0016; B60C 11/0041

(57) ABSTRACT

A method for forming a composite tread is described, wherein the method includes the steps of selecting a first tread compound having a first desired tread property, and selecting a second tread compound having a second desired property, forming a tread by winding a dual layer strip having a first layer formed of the first tread compound and a second layer formed of the second compound, wherein the tread has a first and second zone, wherein each zone is formed by spirally winding the dual layer strip, wherein the first zone is formed of a dual layer strip having a strip ratio of the volumetric proportion of the first compound to the second compound used to form the dual layer strip, wherein the second zone has a different strip ratio than the first zone by varying the volumetric proportion of the first compound to the second compound.

### FIELD OF THE INVENTION

The invention relates in general to tire manufacturing, and more particularly to a method for forming a composite tread or tire component.

### BACKGROUND OF THE INVENTION

Tire manufacturers have progressed to more complicated designs due to an advance in technology as well as a highly competitive industrial environment. In particular, tire designers seek to use multiple rubber compounds in a tire component such as the tread in order to meet customer demands. Using multiple rubber compounds per tire component can result in a huge number of compounds needed to be on hand for the various tire lines of the manufacturer. For cost and efficiency reasons, tire manufacturers seek to limit the number of compounds available, due to the extensive costs associated with each compound. Each compound typically requires the use of a banbury mixer, which involves expensive capital expenditures. Furthermore, banbury mixers have difficulty mixing up tough or stiff rubber compounds. The compounds generated from the banbury mixers are typically shipped to the tire building plants, thus requiring additional costs for transportation. The shelf life of the compounds is not finite, and if not used within a certain time period, is scrapped.

Furthermore, to meet the demands of production, it is desired to change from one rubber compound to another within a single component without a stop in the building of the component. Stopping a build to change rubber material causes a delay in the tire construction process. Tire designers seek a method to transition from one rubber compound to another, or to change the proportion of one rubber compound to another within a certain zone of the tire component, dynamically, or “on the fly”, during component construction to save time and reduce complexity in the tire manufacturing process.

Thus, it is desired to have an improved method and apparatus which provides independent flow of two or more compounds from a single application head. More particularly, it is desired to be able to make a custom tire tread or tire component using only two tire compounds, which can be used to simulate multiple compounds having a variety of properties.

### SUMMARY OF THE INVENTION

The invention provides in one aspect a method for forming a composite tread, wherein the method includes the steps of selecting a first tread compound having a first desired tread property, and selecting a second tread compound having a second desired property, forming a tread by winding a dual layer strip having a first layer formed of the first tread compound and a second layer formed of the second compound, wherein the tread has a first and second zone, wherein each zone is formed by spirally winding the dual layer strip, wherein the first zone is formed of a dual layer strip having a strip ratio of the volumetric proportion of the first compound to the second compound used to form the dual layer strip, wherein the second zone has a different strip ratio than the first zone by varying the volumetric proportion of the first compound to the second compound.

The invention provides in a second aspect a tire having a component, wherein the component is formed from a continuous spiral winding of a dual layer strip having a first layer formed of a first compound, and a second layer formed of a second compound, wherein the cross-sectional shape of the first layer is triangular. The tire component may be a tread, a sidewall, an apex, wedge, or a chafer. Preferably, the cross-sectional shape of the second layer is a trapezoid. More preferably, the dual layer strip has a trapezoidal cross-sectional shape.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Tangent delta”, or “tan delta,” is a ratio of the shear loss modulus, also known as G″, to the shear storage modulus (G′). These properties, namely the G′, G″ and tan delta, characterize the viscoelastic response of a rubber test sample to a tensile deformation at a fixed frequency and temperature, measured at 100° C.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1A is a cross-sectional view of a tire tread formed of a 100% of a first compound A;

FIG. 1B is a cross-sectional view of a tire tread formed of multiple layers of a dual layer strip, wherein the strip has a first and second layer, wherein the first layer is formed of a first compound A and the second layer is formed of a second compound B, wherein the overall ratio of the first compound to the second compound is 70/30;

FIG. 1C is a cross-sectional view of a tire tread formed of multiple layers of a dual layer strip, wherein the strip has a first and second layer, wherein the first layer is formed of a first compound A and the second layer is formed of a second compound B, wherein the overall ratio of the first compound to the second compound is 40/60;

FIG. 1D is a cross-sectional view of a tire tread formed of a 100% of a second compound B;

FIG. 2A is a front perspective view of a dual layer strip, wherein the dual layer strip has a bottom layer formed of 90% of a first compound and a top layer formed of 10% of a second compound;

FIG. 2B is a front perspective view of a dual layer strip having a bottom layer formed of 95% of a first compound and 5% of a second compound;

FIG. 3 illustrates a chart showing the proportion of compound A to compound B in a dual layer strip in order to emulate many different compounds using only two compounds. The emulated compounds have properties in proportion to the ratio of the compound A to compound B;

FIG. 4A is a perspective view of an apparatus for forming a dual strip, while FIG. 4B is a perspective close up cross-sectional view of a nozzle used to form the dual strip; and

FIG. 5 is a close up cross-sectional view of an additional embodiment of a tread formed from a dual strip having a different cross-sectional shape.

### DETAILED DESCRIPTION OF THE INVENTION

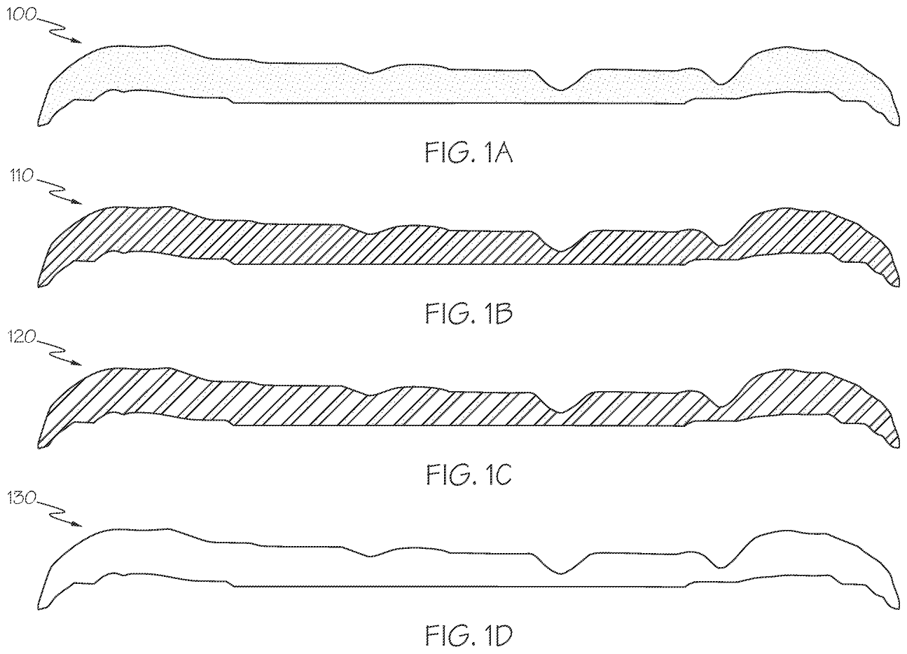

FIG. 1A illustrates a cross-sectional view of a tire tread 100 of the present invention. The tire tread 100 is formed of 100% of a first compound A, wherein the compound A is selected for a first desired property of the tread. In this example, compound A is selected for the property of high rolling resistance, and a tread compound having a highly loaded silica tread formulation is used for the desired tread characteristics. FIG. 1D illustrates a second embodiment of a tire tread 110 of the present invention formed of a second compound B, wherein the compound B is selected for a second desired property of the tread. In this example, the second desired tread property is high dry traction, and a rubber compound selected for dry traction having high amounts of carbon black is utilized.

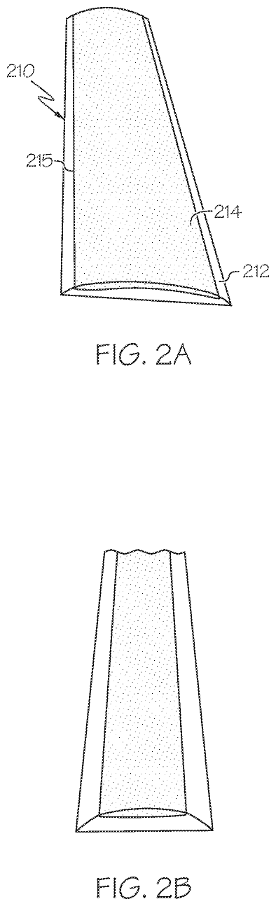

FIG. 1B illustrates a cross-sectional view of a tire tread 110 of the present invention where it is desired to have a tire tread having two desired tread properties. Thus, it is desired to have a tread composition having high rolling resistance and high dry traction. The tire tread 110 is formed of an overall tread composition of 60% compound A and 40% compound B. The tire tread 110 is formed by winding a continuous dual layer strip 210 onto a tire building drum or onto a shaped green carcass. The continuous dual layer strip 210 is shown in FIG. 2A, and has a first base layer 212 formed of compound A and a second layer 214 formed of compound B. The overall compound ratio of the tire tread is 60% compound A and 40% compound B, and is accomplished by spirally winding a dual layer strip having a ratio of 60% compound A to 40% compound B. FIG. 2B illustrates a second dual layer strip having a higher percentage of compound A to compound B.

FIG. 1C illustrates a fourth embodiment of a tread 120 formed of a dual layer strip having a 30% compound A to 70% compound B ratio, thus to form an overall ratio for the tread of 30% A to 70% B.

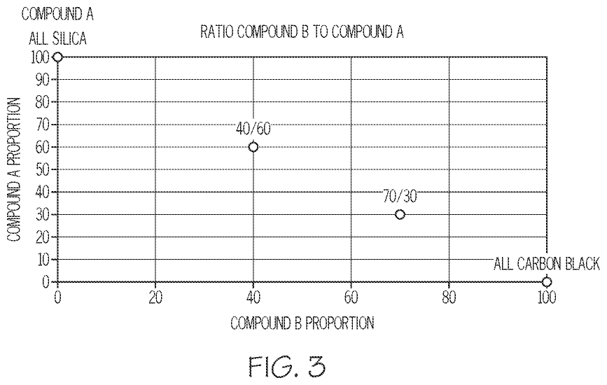

Thus, the tread compound ratios of FIGS. 1A through 1D are illustrated in FIG. 3. Thus, example of the various tread configurations shown in FIGS. 1A through 1D illustrate how the use of two different compounds selected for two different desired properties, can be used to generate a tread formed of different zones. Each zone of the tread can be formed of 100% of compound A or 100% of compound B, or a zone having both compounds A and compound B wherein the compounds A and B are not mixed together. This zone is accomplished by the use of a dual layer strip 210 as shown in FIG. 2A that has two discrete layers of compound A and compound B, and which the ratio of the two compounds in the strip can be varied in real time. Thus invention provides for a tread formed of multiple zones thus simulating the use of many compounds by varying the volume ratio of compound A to compound B. It is important to note that the compound properties of the dual layer can be determined by interpolating between the volumetric ratios of the two compounds. Thus, 100% of compound A will give 100% of the desired property, while 50% of compound A will result in 50% of the desired compound property. In varying the volumetric amount of compound A and compound B, the simulation of multiple compounds can be provided.

In FIG. 3, the two selected compounds A and B are shown. By varying the ratio of compound A to compound B of the strip, results in the variation of the compound properties. Two compounds can be selected for the desired properties such as rolling resistance, stiffness, electrical conductivity, thermal conductivity, wet traction, dry traction, and treadwear. The desired tread properties can then be determined by selecting the desired ratio of the two compounds. The property ratio is determined by interpolating between by varying the ratio of two coextruded and spiral laminated compounds. Thus, structuring two different compounds with mutually exclusive performance properties layered in 0-3 mm configurations yields performances of non-existent compounds between the two parent compounds. Compound ratios in thin 0-3 mm alternating layers oriented at angles from 0-60° to application surface in controlled proportions ranging from 0:100 to 100:0 permits introduction of a definable compromise of tire performances.

Multiple compound layering with layer thickness dimensions less than 3 mm enable the tire component to leverage the properties of each compound while minimizing compound to compound interface durability issues because the thin cross sections of each layer are individually exposed to low stress concentration. Dynamically tuning the ratio of the two parent compounds across the component permits fine tuning of the tire zone performance contribution and delivers a previously unachievable performance.

The 0-3 mm alternating layers of two compounds are achieved with a dual layer strip 0-3 mm in thick and 10-25 mm wide comprised of two compounds with various but definable angles, curves, and proportions of division which is then circumferentially or spirally built-up or laminated on an application surface forming a green tire component. Duplex spiral lamination of two parent compounds to yield the properties of in-between compounds reduces need for compound options and reduces plant complexity while enhancing tire design tunability and reducing development iteration timelines. Plus, different areas of the tire could receive different ratios of the parent compounds to maximize performance contribution.

### Dual Strip Forming Apparatus

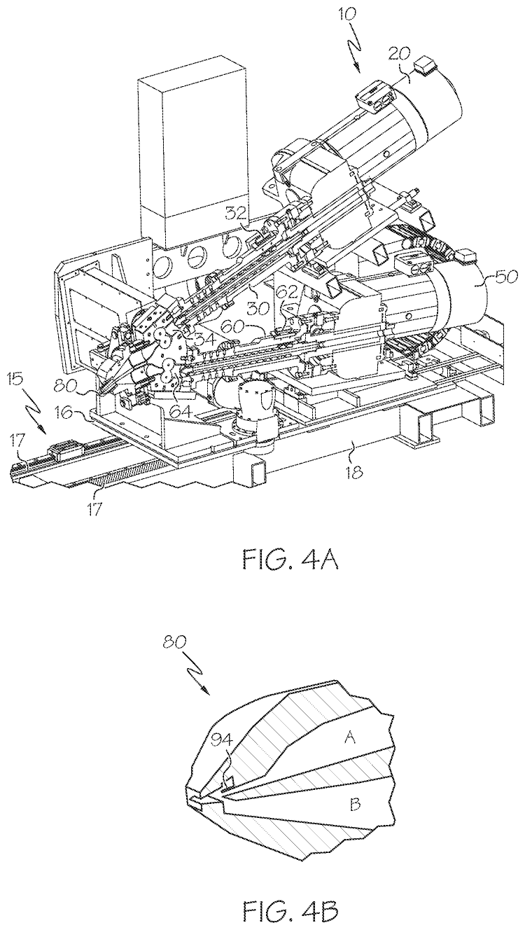

The apparatus used to form the continuous dual layer strip is shown in FIGS. 4A and 4B. The apparatus can form the coextruded strip while instantaneously varying the ratio of the first compound to the second compound. The dual strip forming apparatus 10 includes a first extruder 30 and a second extruder 60, preferably arranged vertically in close proximity. The first extruder 30 has an inlet 32 for receiving a first rubber composition A, while the second extruder 60 has an inlet 62 for receiving a second rubber composition B. Compound A is extruded by the first extruder 60 and then pumped by the first gear pump 62 into a nozzle 80, while at the same time Compound B is extruded by the second extruder 30 and then pumped by the second gear pump 34 into the nozzle 80. The volume ratio of compound A to compound B may be changed by varying the ratio of the speed of gear pump of compound A to the speed of gear pump of compound B. The dual coextruded strip forming apparatus 10 can adjust the speed ratios on the fly, and due to the small residence time of the coextrusion nozzle, the apparatus has a fast response to a change in the compound ratios. This is due to the low volume of the coextrusion zone.

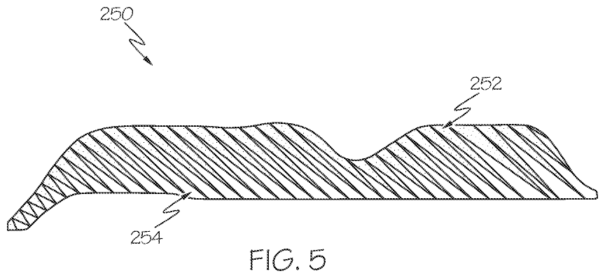

The nozzle 80 forms two discrete layers 212, 214 joined together at an interface 215. The nozzle can be configured to provide different cross-sectional configurations of the strip. The strip of FIGS. 2A and 2B illustrates one embodiment. The duplex strip 250 as shown in FIG. 5 may be used. The duplex strip 250 has a first layer that has a first triangular cross-sectional shape 252, and an inverted triangle 254 forming a second layer. The duplex strips 250 may be spirally wound to form a tread. The first layer compound 252 may be selected for stiffness, while the second layer compound 254 may be selected for traction. The duplex strip 250 is oriented such that the traction layer is located radially outward of the first layer formed of a stiff compound. As shown in FIG. 5, the duplex strips are spirally wound at an angle. Thus, the tire tread as shown in FIG. 5 results in more traction compound near the contact patch and more stiffness compound below the nonskid while minimizing the stiff compound cross sections for crack resistance.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for forming a composite tread, the method comprising the steps of:
selecting a first tread compound having a first desired tread property, and selecting a second tread compound having a second desired property, forming a tread by winding a dual layer strip having a first layer formed of the first tread compound and a second layer formed of the second compound, wherein the tread has a first and second zone, wherein each zone is formed by spirally winding the dual layer strip, wherein the first zone is formed of a dual layer strip having a strip ratio of the volumetric proportion of the first compound to the second compound used to form the dual layer strip, wherein the second zone has a different strip ratio than the first zone by varying the volumetric proportion of the first compound to the second compound.

2. The method of claim 1 wherein the first desired tread property is selected from the group of: rolling resistance, stiffness, electrical conductivity, thermal conductivity, wet traction, dry traction, and wear.

3. The method of claim 1 wherein the second desired tread property is selected from the group of: rolling resistance, stiffness, electrical conductivity, thermal conductivity, wet traction, dry traction, and wear.

4. The method of claim 1 wherein the first desired tread property is different than the second tread property.

5. The method of claim 1 wherein the composite tread further comprises a third zone formed of only the first compound.

6. The method of claim 1 wherein the composite tread further comprises a fourth zone formed of only the second compound.

7. The method of claim 1 wherein a first tread property of a first zone is determined by using linear interpolation of the strip ratio.

8. The method of claim 1 wherein a second tread property of a first zone is determined by using a linear interpolation of the strip ratio.

9. The method of claim 1 further comprising the steps of forming a rib while continuously varying the ratio of the first compound to the second compound.

10. The method of claim 1 wherein the second compound comprises a rubber composition having a shear storage modulus G′ measured at 1% strain and 100° C. according to ASTM D5289 ranging from 23 to 31 MPa.

11. The method of claim 1 wherein the ratio of the first compound to the second compound is varied by changing the ratio of the speed of the first gear pump to the second gear pump.

12. A tire having a component, wherein the component is formed from a continuous spiral winding of a dual layer strip having a first layer formed of a first compound, and a second layer formed of a second compound, wherein the cross-sectional shape of the first layer is triangular.

13. The tire of claim 12 wherein the cross-sectional shape of the second layer is a trapezoid.

14. The tire of claim 13 wherein the dual layer strip has a trapezoidal cross-sectional shape.

15. The tire of claim 12 wherein the component is a tread.

16. The tire of claim 15 wherein the first compound has a first tread property of high stiffness, and the second compound is selected for high traction.

17. The tire of claim 16 wherein the tread is formed by spirally winding a dual layer strip of the first compound having high stiffness and the second compound having high traction, wherein the strips are oriented so that the high traction layer is located radially outward of the high stiffness layer.

18. The tire of claim 17 wherein the strips are overlapped with each other and applied at an angle in the range of 0-60 degrees.
